(19) United States
(12) Patent Application Publication
(10) Pub. No.: US 2022/0000072 A1
(43) Pub. Date: Jan. 6, 2022

(54) All-In-One Pet Cleaning Glove

(71) Applicant: Brandon Cheung, Arcadia, CA (US)

(72) Inventor: Brandon Cheung, Arcadia, CA (US)

(21) Appl. No.: 16/946,738

(22) Filed: Jul. 2, 2020

(51) Int. Cl. A01K 13/00; A46B 1/00; A46B 5/04; A46B 9/00; A46B 11/06

(52) U.S. Cl. CPC A01K 13/001; A46B 1/00; A46B 2200/1093; A46B 9/005; A46B 11/066; A46B 5/04

(57) ABSTRACT

A pet cleaning glove includes a glove body, a scrubbing arrangement, a water supply arrangement and a cleaning supply arrangement. The glove body, which is made of waterproof material, has at least a finger pocket, a thumb pocket, and a palm pocket, and defines a palmar side and a dorsal side. The scrubbing arrangement is provided at the palmar side of the finger pocket and the palmar side of the thumb pocket only. The water supply arrangement includes an inlet port adapted for connecting to a water source and at least an outlet port formed at the palmar side of the finger pocket for dispensing water from the water source. The cleaning supply arrangement is provided at the palmar side of the palm pocket for receiving a cleaning agent, wherein the glove body is folded at the palm pocket thereof for squeezing out the cleaning agent.

### BACKGROUND OF THE PRESENT INVENTION

### Field of Invention

The present invention relates to a pet cleaning apparatus, and more particularly to an all-in-one pet cleaning glove, which comprises a water supply arrangement and a cleaning supply arrangement integrated with a glove body to allow users to wash and rinse pets using a single gloved hand.

### Description of Related Arts

Washing a pet, such as a dog, involves water, fluid soap, and scrubbing device. Generally speaking, a person washing the pet requires one hand to restrain the pet to prevent it from shaking water and/or escape. Therefore, it leaves only one hand, as a non-restraining hand, to hold the water shower head, apply shampoo, and scrubbing the pet. Particularly, the pet owner requires using the non-restraining hand to turn on-and-off the water switch for wetting the pet before shampooing and rinsing the pet and after shampooing. Meanwhile, the pet owner requires using the non-restraining hand to hold the bottle of shampoo to apply the shampoo and to carry the scrubbing device. The restraining hand of the pet owner must remain restrain the pet throughout the entire cleaning operation.

Many existing gloves has a built-in scrubbing side to replace the scrubbing device. Particularly, the glove comprises a plurality of scrubbing members protruded from a palmar side of the glove. However, the scrubbing members will block the movement of the glove to handle the water shower head and the bottle of shampoo.

Therefore, it is necessary to provide a novel technical solution to solve the above problems.

### SUMMARY OF THE PRESENT INVENTION

A main objective of the present invention is to provide an all-in-one pet cleaning glove, which comprises a water supply arrangement and a cleaning supply arrangement integrated with a glove body to allow users to wash and rinse pets using a single gloved hand.

In order to achieve the above objective, an aspect of the present invention provides a pet cleaning glove, which comprises a glove body, a scrubbing arrangement, a water supply arrangement and a cleaning supply arrangement. The glove body, which is made of waterproof material, has at least a finger pocket, a thumb pocket, and a palm pocket, and defines a palmar side and a dorsal side. The scrubbing arrangement is provided at the palmar side of the finger pocket and the palmar side of the thumb pocket only. The water supply arrangement includes an inlet port adapted for connecting to a water source and at least an outlet port formed at the palmar side of the finger pocket for dispensing water from the water source. The cleaning supply arrangement is provided at the palmar side of the palm pocket for receiving a cleaning agent, wherein the glove body is folded at the palm pocket thereof for squeezing out the cleaning agent.

Accordingly, the cleaning agent is released only when the cleaning supply arrangement is squeezed by folding the palm pocket of the glove body, such that the user is able to control how much cleaning agent to be discharged via the squeezing force.

The water flow is controlled by the thumb of the user without taking off the glove body.

The entire cleaning operation is completed by the non-restraining hand of the user, i.e. the single gloved hand thereof, to finish the wetting process, the shampoo applying process, and the rinsing process by one single glove of the present invention.

### BRIEF DESCRIPTION OF THE DRAWINGS

Hereinafter, embodiments of the present invention will be described in detail with reference to the accompanying drawings. The drawings in the embodiments or the description of the prior art are briefly introduced below. The embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

FIG. 1 is a perspective view of a pet cleaning glove according to a first embodiment of the present invention.

FIG. 2 is a side view of the pet cleaning glove according to the first embodiment of the present invention, illustrating the glove body being folded for squeezing the cleaning supply arrangement.

FIG. 3 is a top view of the pet cleaning glove according to the first embodiment of the present invention, illustrating the arrangement of the water supply arrangement.

FIG. 4 is a perspective view of a pet cleaning glove according to a second embodiment of the present invention, illustrating a modification of the first embodiment.

FIG. 5 is a partially sectional view of the pet cleaning glove according to the second embodiment of the present invention, illustrating the water passing from the water pouch through the scrubbing members.

### DETAILED DESCRIPTION OF THE PREFERRED EMBODIMENT

In the following description, for purpose of explanation, numerous specific details are set forth in order to provide a thorough understanding of some example embodiments. It will be evident, however, to one of ordinary skill in the art that embodiments of the present invention may be practiced without these specific details.

It should be appreciated that the terms “comprises” and “comprise” in the following description refer to the feature, unit, step, operation, element, and/or assembly in the accompanying drawings for easy understanding of the present invention. It should not be limited to one or more of features, units, steps, operations, elements, and/or assemblies.

It should be appreciated that the terms “first”, “second”, “one”, “a”, and “an” in the following description refer to “at least one” or “one or more” in the embodiment. In particular, the term “a” in one embodiment may refer to “one” while in another embodiment may refer to “more than one”. Therefore, the above terms should not be an actual numerical limitation of the elements of the present invention.

It should be appreciated that the terms “and” and “or” in the following description may refer to “one” or “more than one” in the accompanying drawings for easy understanding of the present invention without limiting the actual number of the present invention. Therefore, the above terms should not be an actual numerical limitation of the elements of the present invention.

It should be appreciated that the term “if” in the following description may refer to the terms “when”, “once”, or “in response to”. The terms “if determined” or “if detection” in the following description may refer to “once detection”, or “in response to detection”.

It should be appreciated that the terms “first” and “second” in the following description may refer to different areas, regions, or modules, and the terms “first” and “second” should not be actual sequence limitation or should not present different types of the present invention.

In order to explain the technical solution of the present invention, the following description is made through specific embodiments.

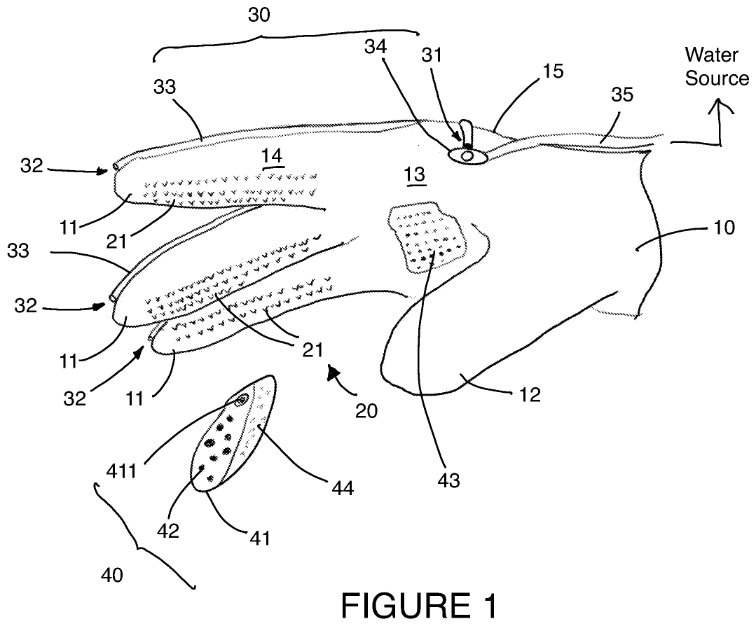

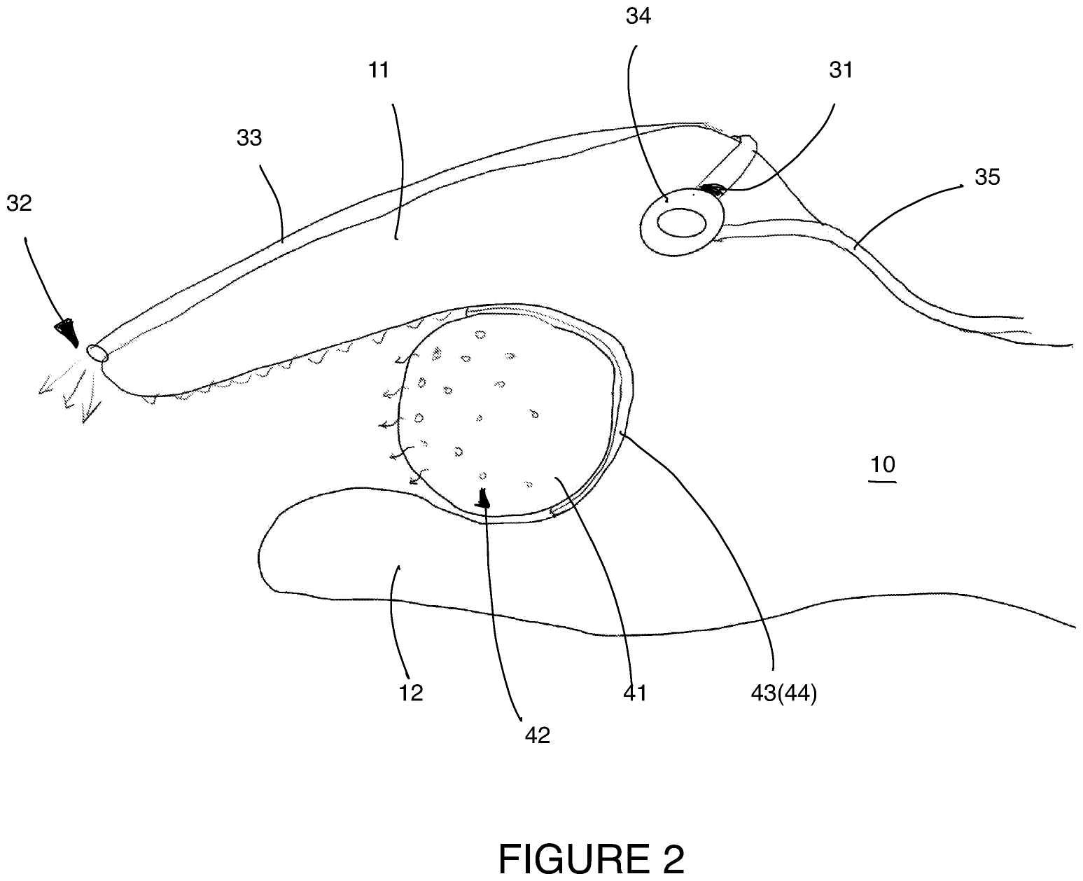

FIGS. 1 and 2 illustrate a pet cleaning glove according to a first embodiment, wherein the pet cleaning glove is an all-in-one pet cleaning glove for wetting a pet, such as a dog as an example, for shampooing the pet, and for rinsing the pet by one single glove with one hand operation. Therefore, the user, as such a pet owner, is able to use one hand as a restraining hand to restrain the pet and another non-restraining hand to complete the entire cleaning operation.

The pet cleaning glove comprises a glove body 10 made of waterproof material. The glove body 10 is constructed to have at least a finger pocket 11, a thumb pocket 12, and a palm pocket 13, wherein the finger pocket 11 and the thumb pocket 12 are extended from the palm pocket 13. The glove body 10 further defines a palmar side 14 and an opposed dorsal side 15. In FIG. 1, the glove body 10 has four finger pockets 11 and one thumb pocket 12, wherein when the glove body 10 is worn by the user, the fingers of the user are received in the finger pockets 11 respectively, the thumb of the user is received in thumb pocket 12, and the palm of the user is received in the palm pocket 13. Preferably, the glove body 10 further has a wrist portion extended from the palm pocket 13 for covering a wrist of the user. The glove body 10 can be a right-handed glove or a left-handed glove, wherein the glove body 10 is made of flexible material for allowing the fingers and the thumb of the user to move or bend freely. It should be appreciated that the glove body 10 can have one enlarged finger pocket 11 to receive the fingers of the user when it is worn.

The pet cleaning glove further comprises a scrubbing arrangement 20 provided at the palmar side 14 of the finger pocket 11 and the palmar side 14 of the thumb pocket 12 only for scrubbing and massaging the pet. In other words, the scrubbing arrangement 20 is not formed at the palmar side 14 of the palm pocket 13 of the glove body 10. In this embodiment, the scrubbing arrangement 20 comprises a plurality of scrubbing members 21 protruded from the palmar side 14 of the finger pocket 11 and the palmar side 14 of the thumb pocket 12 only. Preferably, the scrubbing members 21 are integrally protruded from the palmar side 14 of the finger pocket 11 and the palmar side 14 of the thumb pocket 12 only. Each of the scrubbing members 21 has a conical shape to define a tapered free end.

The pet cleaning glove further comprises a water supply arrangement 30 for wetting and rinsing the pet. The water supply arrangement 30 comprises an inlet port 31 adapted for connecting to a water source and at least an outlet port 32 formed at the palmar side 14 of the finger pocket 11 for dispensing water from the water source. The inlet port 31 is provided at the dorsal side 15 of the glove body 10, such that the inlet port 31 will not reduce the flexibility of the glove body 10 to block the movement of the finger pocket 11 and the thumb pocket 12. Preferably, the inlet port 31 is provided at the dorsal side 15 of the glove body 10 at the palm pocket 13 thereof.

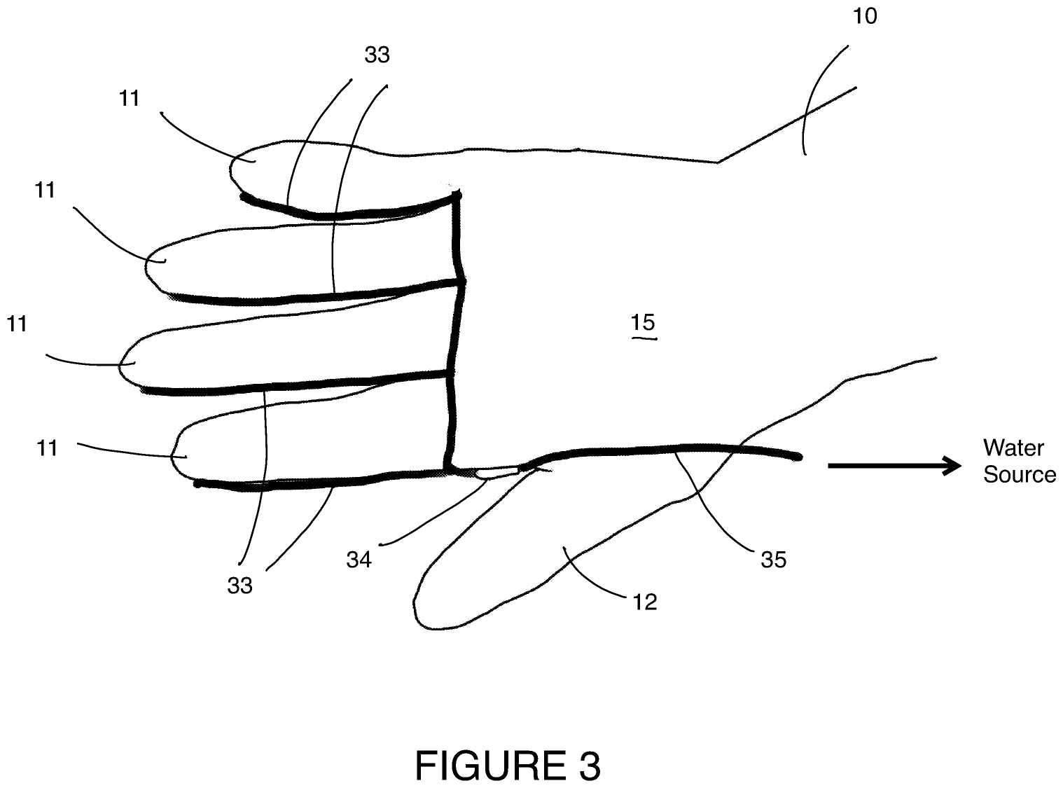

In the first embodiment, the water supply arrangement 30 further comprises at least an elongated water duct 33 extended along a peripheral edge of the finger pocket 11 and connected to the inlet port 31, wherein the outlet port 32 is formed at the water duct 33 for dispensing the water from the water duct 33 to the outlet port 32. As shown in FIGS. 1 to 3, the water duct 33 is extended the peripheral edge of the index finger pocket 11, wherein the outlet port 32 is formed at a free end of the water duct 33 located at a tip of the finger pocket 11. It should be appreciated that when two or more of water ducts 33 are provided, the water ducts 33 are extended along different finger pockets 11 respectively as shown in FIG. 3. It is worth mentioning that since the water duct 33 is flexible and is extended along the peripheral edge of the finger pocket 11, the water duct 33 will not block the movement of the finger of the user in the finger pocket 11.

The water supply arrangement 30 further comprises a thumb water switch 34 formed at a side of the finger pocket 11 adjacent to the thumb pocket 12 in a reachable manner, wherein the user is able to operate the thumb water switch 34 by the thumb of the user to control the water flow. In other words, the thumb water switch 34 is located at a position where the thumb of the user can reach. Accordingly, the thumb water switch 34 is connected at the water duct 33 at the inlet port 31 for controlling the water flow to the outlet port 32. In one example, the thumb water switch 34 can be a pressing button coupled at the water duct 33, wherein via a depression of the thumb water switch 34 by the thumb of the user to control the water flow from the inlet port 31 to the outlet port 32 through the water duct 33. It should be appreciated that the thumb water switch 34 can be a pivot switch, wherein the thumb water switch 34 is pivotally moved at one direction for allowing the water flowing from the inlet port 31 to the outlet port 32 and is pivotally moved at an opposed direction for blocking the water flowing the outlet port 32.

The water supply arrangement 30 further comprises a flexible water tube 35 having one end detachably connecting to the thumb water switch 34 and an opposed end for detachably connecting to the water source. The set up of the pet cleaning glove is simple and easy by detectably connecting the flexible water tube 35 to the thumb water switch 34 to communicate with the water source. The flexible water tube 35 will not block the movement of the glove body 10 when it is worn.

As shown in FIGS. 1 and 2, the pet cleaning glove further comprises a cleaning supply arrangement 40 provided at the palmar side 14 of the palm pocket 13 for receiving a cleaning agent. The cleaning supply arrangement 40 comprises a squeezable cleaning pouch provided at the palmar side 14 of the palm pocket 13 for receiving a soap as the cleaning agent in the squeezable soap pouch 41. In this embodiment, the squeezable cleaning pouch is a squeezable shampoo pouch 41 provided at the palmar side of the palm pocket for receiving a liquid shampoo as the cleaning agent in the squeezable shampoo pouch 41. The squeezable shampoo pouch 41 has a shampoo filling inlet 411 for filling the liquid shampoo therein. Particularly, the squeezable shampoo pouch 41 is made of porous material defining a plurality of dispensing pores 42 formed at the squeezable shampoo pouch 41, such that when the glove body 10 is folded at the palm pocket 13 to squeeze the squeezable shampoo pouch 41, the liquid shampoo is squeezed out of the squeezable shampoo pouch 41 through the dispensing pores 42. In other words, the squeezable shampoo pouch 41 is squeezed to open up the dispensing pores 42 for releasing the liquid shampoo, wherein the liquid shampoo will not be released when the squeezable shampoo pouch 41 is not squeezed as the dispensing pores 42 are closed.

In this embodiment, the squeezable shampoo pouch 41 is detachably coupled at the palmar side 14 of the palm pocket 13 via a detachable unit having a waterproof ability. The detachable unit comprises hook and loop fasteners 43, 44 provided at the palmar side 14 of the palm pocket 13 and a surface of the squeezable shampoo pouch 41 respectively.

In order to use the pet cleaning glove of the present invention, the user is able to firstly connect the flexible water tube 35 between the inlet port 31 and the water source. Meanwhile, the shampoo can be filled in the squeezable shampoo pouch 41. After wearing the glove body 10 at the non-restraining hand of the user, the user is able to switch on the thumb water switch 34 by the thumb of the non-restraining hand of the user to let the water discharging to the outlet port 32 for wetting the pet. Then, the user is able to switch off the thumb water switch 34 by the thumb of non-restraining hand of the user to stop the water flow. At the same time, the shampoo in the squeezable shampoo pouch 41 is dispensed therefrom. Then, the user is able to squeeze the squeezable shampoo pouch 41 by the non-restraining hand of the user to fold the palm pocket 13 of the glove body 10 for squeezing the shampoo out of the squeezable soap pouch 41 through the dispensing pores 42. After the shampoo is applied to the pet, the user is able to clean and wash the pet by scrubbing the pet via the scrubbing members 21. It is worth mentioning that the user should use thumb and fingers to scrub the roots of the pet hairs but not the palm because it can gently massage the cleaning agent into the roots of the pet hairs. Therefore, the scrubbing members 21 are formed at the palmar side 14 of the finger pocket 11 and the palmar side 14 of the thumb pocket 12 only but not the palm pocket 13. In case there is not enough shampoo, the user is able to squeeze the squeezable shampoo pouch 41 again to apply the shampoo to the pet. Once the pet is shampooed, the user is able to switch on the thumb water switch 34 by the thumb of the non-restraining hand of the user to let the water discharging to the outlet port 32 for rinsing the pet. The entire cleaning operation is completed by the non-restraining hand of the user, i.e. the single gloved hand thereof, such that the cleaning operation is a one hand operation via the pet cleaning glove of the present invention.

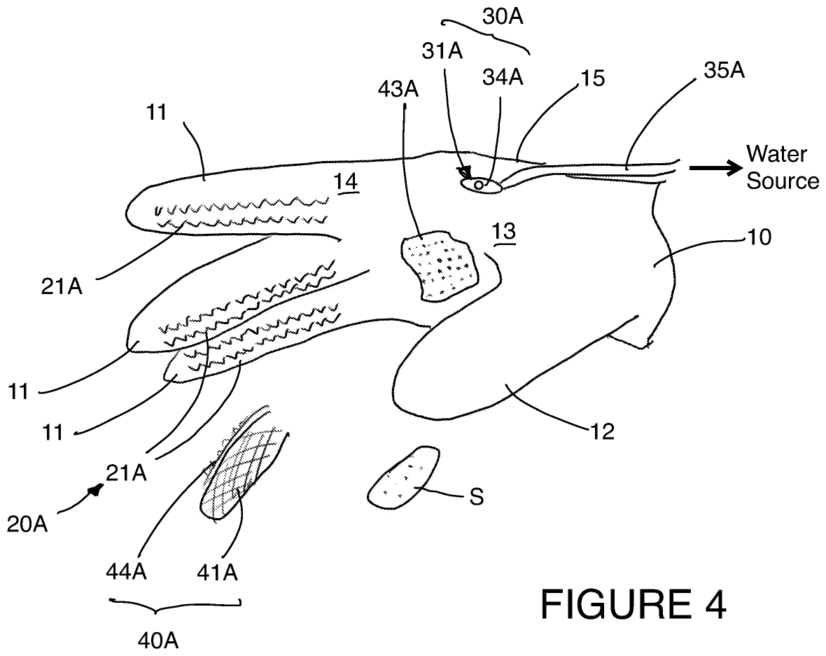

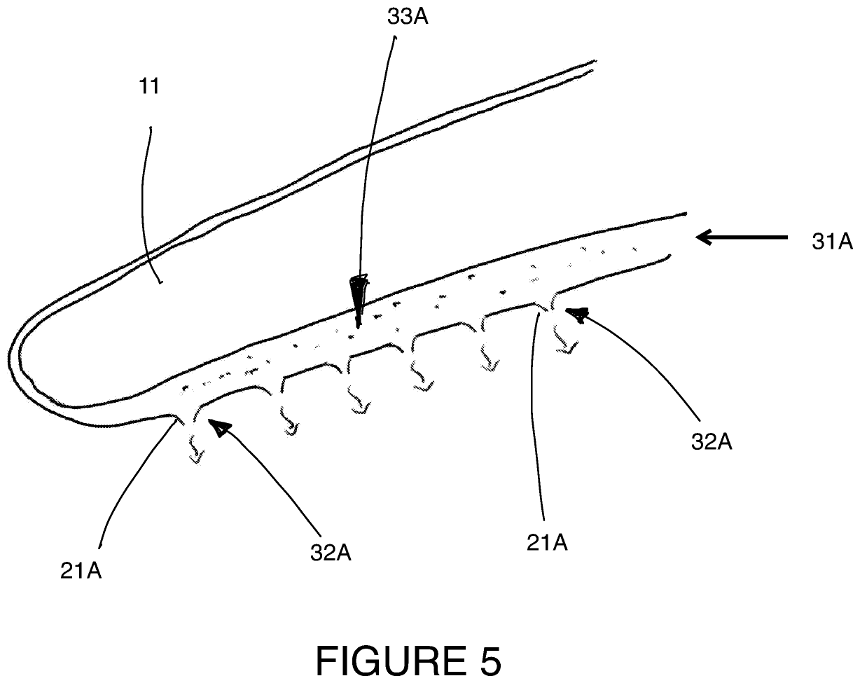

FIGS. 4 and 5 illustrate a pet cleaning glove according to a second embodiment as an alternative of the first embodiment. The pet cleaning glove of the second embodiment has the same structural configuration of the first embodiment, except the scrubbing arrangement 20A, the water supply arrangement 30A and the cleaning supply arrangement 40A.

The scrubbing arrangement 20A provided at the palmar side 14 of the finger pocket 11 and the palmar side 14 of the thumb pocket 12 only for scrubbing and massaging the pet. The scrubbing arrangement 20A comprises a plurality of scrubbing members 21A protruded from the palmar side 14 of the finger pocket 11 and the palmar side 14 of the thumb pocket 12 only. Preferably, the scrubbing members 21A are integrally protruded from the palmar side 14 of the finger pocket 11 and the palmar side 14 of the thumb pocket 12 only. Each of the scrubbing members 21A has a conical shape to define a tapered free end. Particularly, each of the scrubbing member 21A has a hollow structure.

The water supply arrangement 30A comprises an inlet port 31A adapted for connecting to a water source and at least an outlet port 32A formed at the palmar side 14 of the finger pocket 11 for dispensing water from the water source. The inlet port 31A is provided at the dorsal side 15 of the glove body 10, such that the inlet port 31A will not reduce the flexibility of the glove body 10 to block the movement of the finger pocket 11 and the thumb pocket 12. Preferably, the inlet port 31A is provided at the dorsal side 15 of the glove body 10 at the palm pocket 13 thereof.

In the second embodiment, the water supply arrangement 30 further comprises at least a water pouch 33A formed in the finger pocket 11, wherein each of the scrubbing members 21A has the hollow structure forming the outlet port 32A thereat for dispensing the water from the water pouch 33A to the outlet ports 32A through the scrubbing members 21A. Particularly, the outlet port 32A is formed at the tapered free end of each of the scrubbing members 21A. In other words, the water pouch 33A is built-in with the glove body 10. Accordingly, the scrubbing members 21A are formed not only for scrubbing the pet but also discharging water to the pet.

The water supply arrangement 30A further comprises a thumb water switch 34A formed at a side of the finger pocket 11 adjacent to the thumb pocket 12 in a reachable manner, wherein the user is able to operate the thumb water switch 34A by the thumb of the user to control the water flow. Accordingly, the thumb water switch 34A is connected at the water pouch 33A at the inlet port 31A for controlling the water flow to the outlet port 32A. It is worth mentioning that when the water pouch 33A is inflated by the water, the water can be discharged through the scrubbing members 21A at the palmar side 14 of the finger pocket 11 and the palmar side 14 of the thumb pocket 12 for enlarging the water coverage area. When the water pouch 33A is deflated to empty the water therein, the finger pocket 11 and the thumb pocket 12 are free to move for scrubbing the pet.

The water supply arrangement 30A further comprises a flexible water tube 35A having one end detachably connecting to the inlet port 31A and an opposed end for detachably connecting to the water source.

The cleaning supply arrangement 40A provided at the palmar side 14 of the palm pocket 13 for receiving a cleaning agent. In this embodiment, the squeezable cleaning pouch is a squeezable soap pouch 41A provided at the palmar side 14 of the palm pocket 13 for receiving a soap S as the cleaning agent in the squeezable soap pouch 41A. The soap can be shampoo in bar form. The squeezable soap pouch 41A has a side opening for receiving the solid soap S therein. Particularly, the squeezable soap pouch 41A is made of porous material defining a plurality of dispensing pores 42A, such that when the glove body 10 is folded at the palm pocket 13 to squeeze the squeezable soap pouch 41A, a soap water is squeezed out of the squeezable soap pouch 41A through the dispensing pores 42A after the soap is mixed and dissolved with the water. In other words, the squeezable soap pouch 41A is squeezed to open up the dispensing pores 42A for releasing the soap water, wherein the soap water will not be released when the squeezable soap pouch 41A is not squeezed as the dispensing pores 42A are closed.

In the second embodiment, the squeezable soap pouch 41A is detachably coupled at the palmar side 14 of the palm pocket 13 via a detachable unit having a waterproof ability. The detachable unit comprises hook and loop fasteners 43A, 44A provided at the palmar side 14 of the palm pocket 13 and a surface of the squeezable soap pouch 41A respectively.

The use of the pet cleaning glove of the second embodiment is the same as the first embodiment. Accordingly, the features of the first and second embodiments are interchangeable. For example, the squeezable shampoo pouch 41 and the squeezable soap pouch 41A in the first and second embodiments are interchangeable, and the water duct 33A and the built-in water pouch 33A of the first and second embodiment are interchangeable.

The above description is only the preferred embodiment of the present invention, and is not intended to be limiting. The present invention should include all modifications, equivalent substitutions and improvements made within the spirit and principles of the present invention.

What is claimed is:

1. A pet cleaning glove, comprising:
a glove body, which is made of waterproof material, having at least a finger pocket, a thumb pocket, and a palm pocket, and defining a palmar side and a dorsal side;
a scrubbing arrangement which comprises a plurality of scrubbing members protruded from said palmar side of said finger pocket and said palmar side of said thumb pocket only;
a water supply arrangement which comprises an inlet port adapted for connecting to a water source and at least an outlet port formed at said palmar side of said finger pocket for dispensing water from the water source; and
a cleaning supply arrangement provided at said palmar side of said palm pocket for receiving a cleaning agent, wherein said glove body is folded at said palm pocket thereof for squeezing out the cleaning agent.

2. The pet cleaning glove, as recited in claim 1, wherein said water supply arrangement further comprises at least an elongated water duct extended along a peripheral edge of said finger pocket and connected to said inlet port, wherein said outlet port is formed at said water duct for dispensing the water from said water duct to said outlet port.

3. The pet cleaning glove, as recited in claim 1, wherein said water supply arrangement further comprises at least a water pouch formed in said finger pocket, wherein each of said scrubbing members has a hollow structure forming said outlet port thereat for dispensing the water from said water pouch to said outlet ports through said scrubbing members.

4. The pet cleaning glove, as recited in claim 2, wherein said water supply arrangement further comprises a thumb water switch formed at a side of said finger pocket adjacent to said thumb pocket in a reachable manner, wherein said thumb water switch is connected at said inlet port for controlling the water flow to said outlet port.

5. The pet cleaning glove, as recited in claim 3, wherein said water supply arrangement further comprises a thumb water switch formed at a side of said finger pocket adjacent to said thumb pocket in a reachable manner, wherein said thumb water switch is connected at said inlet port for controlling the water flow to said outlet port.

6. The pet cleaning glove, as recited in claim 4, wherein said water supply arrangement further comprises a flexible water tube having one end detachably connecting to said thumb water switch and an opposed end for detachably connecting to the water source.

7. The pet cleaning glove, as recited in claim 5, wherein said water supply arrangement further comprises a flexible water tube having one end detachably connecting to said thumb water switch and an opposed end for detachably connecting to the water source.

8. The pet cleaning glove, as recited in claim 1, wherein said cleaning supply arrangement comprises a squeezable shampoo pouch provided at said palmar side of said palm pocket for receiving a liquid shampoo as the cleaning agent in said squeezable shampoo pouch, and a plurality of dispensing pores formed at said squeezable shampoo pouch, such that when said glove body is folded at said palm pocket to squeeze said squeezable shampoo pouch, the liquid shampoo is squeezed out of said squeezable shampoo pouch through said dispensing pores.

9. The pet cleaning glove, as recited in claim 6, wherein said cleaning supply arrangement comprises a squeezable shampoo pouch provided at said palmar side of said palm pocket for receiving a liquid shampoo as the cleaning agent in said squeezable shampoo pouch, and a plurality of dispensing pores formed at said squeezable shampoo pouch, such that when said glove body is folded at said palm pocket to squeeze said squeezable shampoo pouch, the liquid shampoo is squeezed out of said squeezable shampoo pouch through said dispensing pores.

10. The pet cleaning glove, as recited in claim 7, wherein said cleaning supply arrangement comprises a squeezable shampoo pouch provided at said palmar side of said palm pocket for receiving a liquid shampoo as the cleaning agent in said squeezable shampoo pouch, and a plurality of dispensing pores formed at said squeezable shampoo pouch, such that when said glove body is folded at said palm pocket to squeeze said squeezable shampoo pouch, the liquid shampoo is squeezed out of said squeezable shampoo pouch through said dispensing pores.

11. The pet cleaning glove, as recited in claim 9, wherein said squeezable soap pouch is detachably coupled at said palmar side of said palm pocket.

12. The pet cleaning glove, as recited in claim 10, wherein said squeezable soap pouch is detachably coupled at said palmar side of said palm pocket.

13. The pet cleaning glove, as recited in claim 1, wherein said cleaning supply arrangement comprises a squeezable soap pouch provided at said palmar side of said palm pocket for receiving a soap as the cleaning agent in said squeezable soap pouch, wherein said squeezable soap pouch is made of porous material defining a plurality of dispensing pores, such that when said glove body is folded at said palm pocket to squeeze said squeezable soap pouch, a soap water is squeezed out of said squeezable soap pouch through said dispensing pores after the soap is mixed and dissolved with the water.

14. The pet cleaning glove, as recited in claim 11, wherein said cleaning supply arrangement comprises a squeezable soap pouch provided at said palmar side of said palm pocket for receiving a soap as the cleaning agent in said squeezable soap pouch, wherein said squeezable soap pouch is made of porous material defining a plurality of dispensing pores, such that when said glove body is folded at said palm pocket to squeeze said squeezable soap pouch, a soap water is squeezed out of said squeezable soap pouch through said dispensing pores after the soap is mixed and dissolved with the water.

15. The pet cleaning glove, as recited in claim 12, wherein said cleaning supply arrangement comprises a squeezable soap pouch provided at said palmar side of said palm pocket for receiving a soap as the cleaning agent in said squeezable soap pouch, wherein said squeezable soap pouch is made of porous material defining a plurality of dispensing pores, such that when said glove body is folded at said palm pocket to squeeze said squeezable soap pouch, a soap water is squeezed out of said squeezable soap pouch through said dispensing pores after the soap is mixed and dissolved with the water.

16. The pet cleaning glove, as recited in claim 14, wherein said squeezable shampoo pouch is detachably coupled at said palmar side of said palm pocket.

17. The pet cleaning glove, as recited in claim 15, wherein said squeezable shampoo pouch is detachably coupled at said palmar side of said palm pocket.

18. The pet cleaning glove, as recited in claim 1, wherein said scrubbing members are integrally protruded from said palmar side of said finger pocket and said palmar side of said thumb pocket only, wherein each of said scrubbing members has a conical shape to define a tapered free end.

19. The pet cleaning glove, as recited in claim 1, wherein said glove body is constructed to have four of said finger pockets extended from said palm pocket, such that said outlet ports are provided at said finger pockets.

20. The pet cleaning glove, as recited in claim 1, wherein said inlet port is provided at said dorsal side of said glove body at said palm pocket thereof.
